(19) United States
(12) Patent Application Publication
(10) Pub. No.: US 2026/0117722 A1
(43) Pub. Date: Apr. 30, 2026

(54) CONTROL DEVICE FOR INTERNAL COMBUSTION ENGINE

(71) Applicant: TOYOTA JIDOSHA KABUSHIKI KAISHA, Toyota-shi (JP)

(72) Inventors: Atsushi YUI, Toyota-shi (JP); Hibiki Ueura, Toyota-shi (JP); Tatsunobu Hattori, Seto-shi (JP)

(73) Assignee: TOYOTA JIDOSHA KABUSHIKI KAISHA, Toyota-shi (JP)

(21) Appl. No.: 19/307,744

(22) Filed: Aug. 22, 2025

(30) Foreign Application Priority Data
Oct. 31, 2024 (JP) 2024-192136

(51) Int. Cl. F02D 41/26; F02D 41/00

(52) U.S. Cl. CPC F02D 41/263; F02D 41/0027; F02D 2200/0802; F02D 2200/1002; F02D 2200/1015; F02D 2250/26

(57) ABSTRACT

The control device of the internal combustion engine is applied to an internal combustion engine that uses hydrogen as fuel, and limits the amount of fuel supplied to the internal combustion engine according to a required torque. The control device of the internal combustion engine includes a processing circuit. When a misfire is detected in the internal combustion engine, the processing circuit performs a torque limit for reducing the torque upper limit value, which is the upper limit of the required torque. When the temperature of the hydrogen processing catalyst, which is an exhaust control catalyst provided in the exhaust path of the internal combustion engine, is lower than the predetermined temperature when the misfire is detected, the processing circuit reduces the torque upper limit value more than when the temperature of the hydrogen processing catalyst when the misfire is detected is equal to or higher than the predetermined temperature.

### CROSS-REFERENCE TO RELATED APPLICATION

This application claims priority to Japanese Patent Application No. 2024-192136 filed on October 31, 2024. The disclosure of the above-identified application, including the specification, drawings, and claims, is incorporated by reference herein in its entirety.

### BACKGROUND

### 1. Technical Field

The present disclosure relates to a control device for an internal combustion engine.

### 2. Description of Related Art

Japanese Unexamined Patent Application Publication No. 06-088542 (JP 06-088542 A) discloses a control device that controls an internal combustion engine that uses hydrogen as a fuel. The control device supplies air and hydrogen into cylinders and causes combustion such that the air-fuel ratio of air and hydrogen is leaner than the stoichiometric air-fuel ratio in all operating states.

### SUMMARY

The above-described control device suppresses generation of unburned hydrogen after the combustion by setting the air-fuel ratio of the air-fuel mixture to the lean side. However, when a misfire occurs in the cylinders, unburned hydrogen is discharged to the outside through an exhaust pipe.

In order to address the above issue, an aspect provides a control device for an internal combustion engine that is applied to the internal combustion engine using hydrogen as a fuel, and that controls a fuel supply amount for the internal combustion engine in accordance with required torque.

The control device for an internal combustion engine includes a processing circuit.

The processing circuit of the control device for an internal combustion engine performs torque limitation to reduce a torque upper limit value as an upper limit of the required torque when a misfire in the internal combustion engine is detected.

When a temperature of an exhaust control catalyst provided in an exhaust path of the internal combustion engine at a time when the misfire is detected is lower than a predetermined temperature, the processing circuit of the control device for an internal combustion engine reduces the torque upper limit value to be less that at a time when the temperature of the exhaust control catalyst at the time when the misfire is detected is equal to or higher than the predetermined temperature.

According to the control device for an internal combustion engine described above, it is possible to suppress unburned hydrogen due to a misfire being discharged to the outside through an exhaust pipe even when the processing activity of the exhaust control catalyst is low.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic top view of a vehicle equipped with a control device, which is an embodiment of a control device for an internal combustion engine;

FIG. 2 is a schematic view of an internal combustion engine mounted on the vehicle of FIG. 1;

FIG. 3 is a flowchart illustrating processing when the processing circuit of the control device of FIG. 1 performs torque limiting;

FIG. 4 is a schematic diagram illustrating a torque limit map stored in a storage device of the control device of FIG. 1;

FIG. 5 is a flowchart showing a process of selecting a torque limit map by the processing circuit executing the process of FIG. 3; and

FIG. 6 is a flowchart illustrating a process of selecting a torque limit map by the processing circuit that executes the process of FIG. 3 in the second embodiment.

### DETAILED DESCRIPTION OF EMBODIMENTS

### First Embodiment

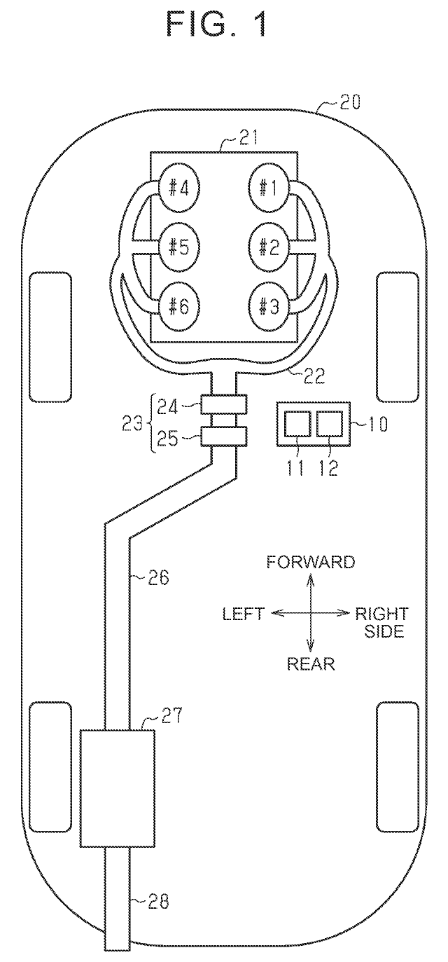

Hereinafter, a first embodiment of a control device 10, which is an embodiment of a control device for an internal combustion engine, will be described with reference to FIGS. 1 to 5.

### Configuration of the vehicle 20

FIG. 1 is a schematic top view of a vehicle 20 on which a control device 10 is mounted as viewed from above the vehicle. The vehicle 20 is a hydrogen engine vehicle including an engine 21 that is an internal combustion engine using hydrogen as a fuel, and a control device 10 that is a control device for the engine 21.

In the vehicle 20, the engine 21 is mounted, for example, at a position on the front side of the vehicle 20, more specifically, at a position further on the front side from the position of the front wheels of the vehicle 20. The engine 21 is a six-cylinder engine including six cylinders #1 to #6. The vehicle 20 includes an exhaust path extending from the engine 21 toward the rear side to the rear end of the vehicle 20.

The vehicle 20 discharges the exhaust gas from the engine 21 to the outside of the vehicle 20 via the exhaust path. The exhaust path includes an exhaust manifold 22, an exhaust pipe 26, a muffler 27, and a tail pipe 28. The exhaust gas discharged from the engine 21 passes through the above-described exhaust path in the order of the exhaust manifold 22, the exhaust pipe 26, the muffler 27, and the tail pipe 28, and flows out of the vehicle 20.

A catalyst device 23 is provided in the middle of the exhaust pipe 26. The catalyst device 23 includes a hydrogen processing catalyst 24 and a SCR catalyst 25. The hydrogen processing catalyst 24 is an exhaust control catalyst provided in an exhaust path of the engine 21 in order to control unburned hydrogen that has not been burned in the engine 21. The hydrogen processing catalyst 24 is, for example, an oxidation catalyst that converts unburned hydrogen into water by an oxidation reaction. SCR catalyst 25 is a NOx removing catalyst that removes nitrogen oxides. The vehicle 20 removes harmful substances generated by combustion by using the above-described catalyst device 23.

### Configuration of the control device 10

As illustrated in FIG. 1, the control device 10 includes a processing circuit 11 and a storage device 12. The processing circuit 11 includes a CPU that executes processing according to a program, and a ROM in which the program is stored. The storage device 12 includes a nonvolatile memory for recording data. The storage device 12 stores information related to the control of the engine 21 in the nonvolatile memory.

The control device 10 is, for example, one of control devices incorporated in an engine ECU (Electronic Control Unit) mounted on the vehicle 20. The control device 10 controls the ignition timing of the engine 21, the opening and closing timing of the intake and exhaust valves, the supply amount of hydrogen as fuel, and the like.

### Configuration of the engine 21

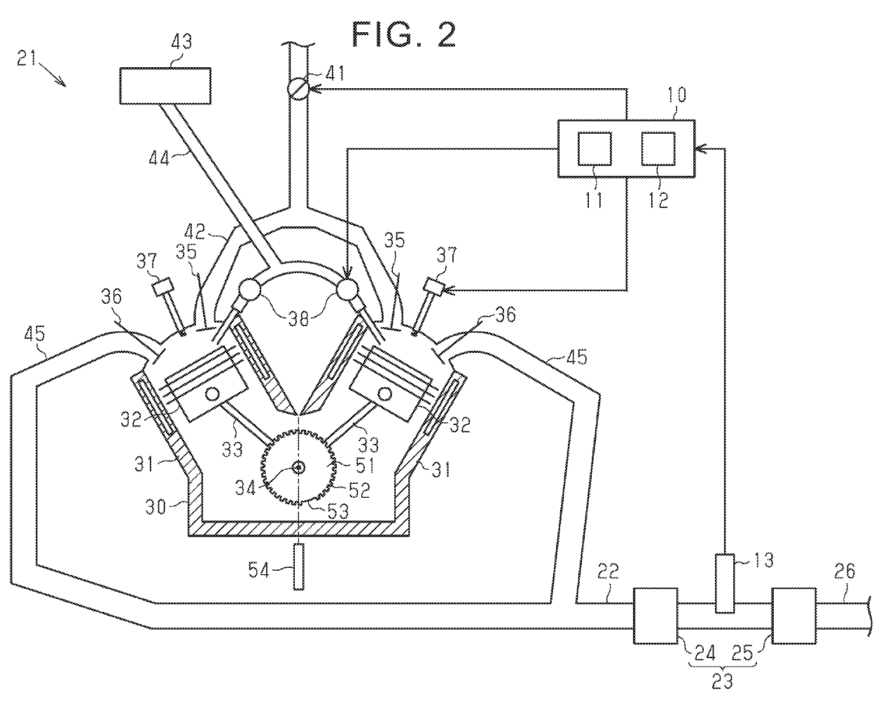

As illustrated in FIG. 2, the engine 21 includes a crankcase 30, a plurality of cylinders 31, an intake passage 42, and an exhaust passage 45. The cylinder 31 is a space for burning the air-fuel mixture of hydrogen and intake air. A piston 32 and a connecting rod 33 are accommodated in the cylinder 31. The connecting rod 33 is connected to a crankshaft 34 accommodated in the crankcase 30.

An intake valve 35, an exhaust valve 36, an ignition device 37, and an injector 38 are provided in an upper portion of the cylinder 31. The engine 21 is a V-shaped internal combustion engine having two banks forming a V-shape. The engine 21 has three cylinders 31 arranged in a row for each bank. That is, the engine 21 is a V-type 6-cylinder engine having six cylinders 31 in both banks. In FIG. 2, the banks are illustrated so that the three cylinders 31 are aligned in a direction perpendicular to the paper surface.

The piston 32 reciprocates inside the cylinder 31 by burning an air-fuel mixture of hydrogen and intake air in the cylinder 31. The reciprocating motion of the piston 32 rotates the crankshaft 34.

The intake passage 42 is connected to the cylinder 31. The intake passage 42 is a passage for introducing intake air from the outside of the engine 21 to each of the cylinders 31. The intake valve 35 is located at the downstream end of the intake passage 42 at the opening of the intake passage 42 to the cylinder 31. The intake valve 35 opens and closes the opening by a driving force from a valve mechanism (not shown). Further, a throttle valve 41 is provided in the middle of the intake passage 42. The throttle valve 41 adjusts the amount of intake air flowing through the intake passage 42.

The exhaust passage 45 is connected to the cylinder 31. The exhaust passage 45 is a passage for discharging exhaust gas from each cylinder 31 to the outside of the engine 21. The exhaust valve 36 is located at an upstream end of the exhaust passage 45 at an opening of the exhaust passage 45 to the cylinder 31. The exhaust valve 36 opens and closes the opening by a driving force from a valve mechanism (not shown). The exhaust gas discharged from the respective cylinders 31 through the exhaust passage 45 in this way collects one by the exhaust manifold 22, and then flows into the exhaust pipe 26. In the middle of the exhaust pipe 26, the catalyst device 23 and the exhaust temperature sensor 13 are provided. The exhaust temperature sensor 13 is a sensor that measures the temperature of the exhaust gas flowing inside the exhaust pipe 26. The exhaust temperature sensor 13 is provided at a position between the hydrogen processing catalyst 24 and SCR catalyst 25 in the exhaust pipe 26. The exhaust temperature sensor 13 measures the temperature of the exhaust gas after passing through the hydrogen processing catalyst 24.

As illustrated in FIG. 2, the engine 21 includes a fuel tank 43 and a fuel supply path 44. The fuel tank 43 is filled with hydrogen, which is fuel. The fuel supply path 44 is connected at one end to the fuel tank 43 and at the other end to the injector 38, and is a path for supplying hydrogen in the fuel tank 43 to the injector 38. The injector 38 supplies hydrogen to the cylinder 31 in accordance with the reciprocating motion of the piston 32. The engine 21 is a direct injection type internal combustion engine, and the injector 38 is directly inserted into the cylinder 31. The hydrogen supplied into the cylinder 31 is mixed with the intake air flowing through the intake passage 42, and then ignited and burned by spark discharge by the ignition device 37.

The control device 10 is connected to the exhaust temperature sensor 13, the ignition device 37, the injector 38, and the throttle valve 41, respectively. In FIG. 2, similarly to the ignition device 37 and the injector 38 provided in the cylinder 31 of the right bank in FIG. 2, the ignition device 37 and the injector 38 provided in the cylinder 31 of the left bank in FIG. 2 are also connected to the control device 10. The processing circuit 11 controls the ignition timing, the fuel supply amount, the intake air amount, and the like in the engine 21 based on the exhaust temperature information input from the exhaust temperature sensor 13. In particular, the processing circuit 11 of the control device 10 controls the amount of fuel supplied to the engine 21 in accordance with the required torque of the vehicle 20. Specifically, the processing circuit 11 calculates a fuel supply amount necessary for realizing the required torque in accordance with the required torque. The processing circuit 11 controls the injector 38 so as to realize the calculated fuel supply amount. The required torque is determined based on information such as a vehicle speed, an accelerator operation amount, an engine rotation speed, and a gear ratio.

### Configuration of misfire detection unit and misfire detection

In the engine 21, a misfire that does not cause combustion of hydrogen may occur in the combustion process of the cylinder 31. When a misfire occurs, the unburned hydrogen remaining to be burned is discharged to the exhaust passage 45. When the unburned hydrogen is not oxidized by the hydrogen processing catalyst 24, the unburned hydrogen is discharged to the outside of the vehicle 20 through the exhaust path.

The processing circuit 11 detects misfire in the engine 21 as follows based on the output from the misfire detection unit.

As illustrated in FIG. 2, the misfire detection unit includes a substantially disk-shaped rotor 51 and a crank angle sensor 54. The rotor 51 rotates integrally with the crankshaft 34 by being fixed to the crankshaft 34. The rotor 51 is provided with teeth 52 and a toothless portion 53. The teeth 52 are provided at equal intervals in the peripheral portion of the rotor 51. The toothless portion 53 is provided at only one position on the rotor 51, and is a portion where the distance between adjacent teeth 52 is wide. Specifically, the rotor 51 has 34 teeth 52 provided at each center angle of 10 degrees of the rotor 51. The toothless portion 53 is a portion where two teeth 52 provided at the above-described intervals are just missing. That is, the adjacent teeth 52 across the toothless portion 53 are provided at intervals of just 30 degrees at the center angle of the rotor 51.

The crank angle sensor 54 is provided toward a peripheral portion of the rotor 51 so as to face the teeth 52. The crank angle sensor 54 determines the distance between the tooth 52 and the crank angle sensor 54 and outputs a signal to the processing circuit 11. For example, when the crank angle sensor 54 is facing the tooth 52, the first signal is output. For example, when the crank angle sensor 54 faces the gap between the teeth 52, a second signal is output. The processing circuit 11 calculates the rotational fluctuation amount of the crankshaft 34 based on these signals output from the crank angle sensor 54. For example, the processing circuit 11 calculates a T30, which is the period required for the crankshaft 34 to rotate 30°CA, based on the output of the crank angle sensor 54. The processing circuit 11 detects misfire based on T30 as follows.

For example, the processing circuit 11 calculates a T30 [60] that is a T30 from ATDC60°CA to 30°CA of the crank angle for the respective cylinders 31. ATDC60°CA is the crank angle from the top dead center TDC to 60°CA retard angle. The processing circuit 11 calculates T30 [0] that is T30 from the top dead center TDC to 30°CA rotational speed of the crank angle for the respective cylinders 31. In the cylinder 31, when hydrogen is normally burned, T30 [60] is smaller than T30 [0]. However, when a misfire occurs in the cylinder 31, T30 [60] becomes larger than T30 [0]. The processing circuit 11 detects the presence or absence of misfire in each cylinder 31 by comparing T30 [60] and T30 [0] for each cylinder 31. When it is determined that T30 [60] is larger than T30 [0] in any one of the cylinders 31 from #1 to #6, the processing circuit 11 detects a misfire in the cylinder 31.

### Torque limit at misfire detection

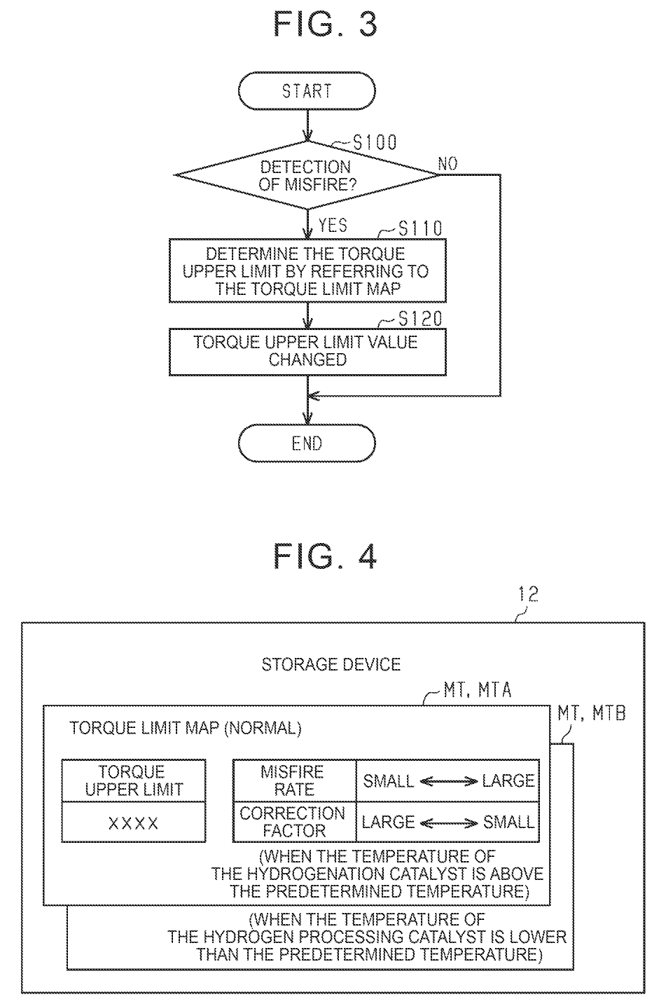

FIG. 3 is a flowchart showing a process performed when the processing circuit 11 performs torque limiting to reduce the torque upper limit value, which is the upper limit value of the required torque, when a misfire is detected in the cylinder 31 of the engine 21. For example, the processing circuit 11 repeatedly executes the processing illustrated in FIG. 3 from the time when the engine 21 is started.

In S100, the processing circuit 11 determines whether a misfire has been detected in any of the cylinders 31 of the engine 21 in the above-described manner. When no misfire is detected in any of the cylinders 31 (S100; NO), the processing circuit 11 temporarily ends the processing of FIG. 3. When a misfire is detected in any of the cylinders 31 (S100; YES), the processing circuit 11 advances the processing to S110.

In S110, the processing circuit 11 determines the torque upper limit by referring to the torque limit map MT.

FIG. 4 is a schematic diagram of the torque limit map MT stored in the storage device 12 of the control device 10. The torque limit map MT includes a predetermined torque upper limit used when the processing circuit 11 detects a misfire and performs torque limit. In S110, the processing circuit 11 refers to the torque limit map MT stored in the storage device 12 and acquires a predetermined torque upper limit. Then, the processing circuit 11 determines the torque upper limit value as the torque upper limit value at the time of performing the torque limit.

Next, in S120, the processing circuit 11 changes the torque upper limit value to the torque upper limit value determined in S110.

When S120 processing is executed, the processing circuit 11 temporarily ends the processing illustrated in FIG. 3.

As described above, the processing circuit 11 performs the torque limit by changing the torque upper limit value when the misfire is detected. On the other hand, the processing circuit 11 does not change the torque upper limit value when no misfire is detected.

### Torque limit map MT selection

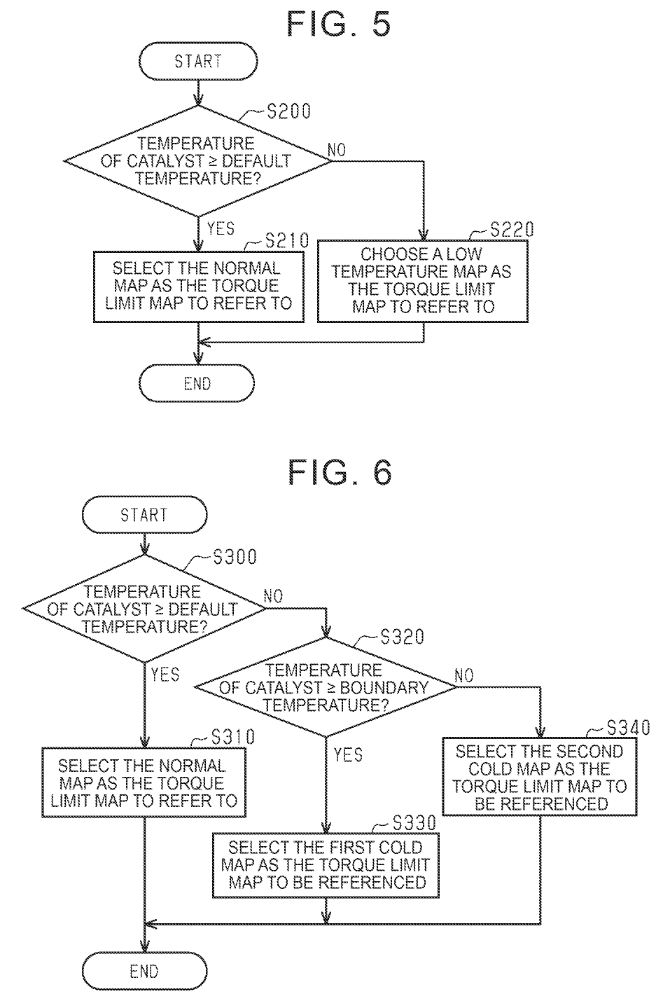

FIG. 5 is a flowchart illustrating a process in which the processing circuit 11 selects a torque limit map MT to be referred to in the process of S110 of FIG. 3 based on the temperature of the hydrogen processing catalyst 24. The processing circuit 11 repeatedly executes the processing illustrated in FIG. 5, for example, at predetermined time intervals while the engine 21 is in operation.

In S200, the processing circuit 11 determines whether or not the temperature of the hydrogen processing catalyst 24 is equal to or higher than a predetermined temperature. The predetermined temperature is, for example, the lowest temperature at which the hydrogen processing catalyst 24 is sufficiently activated and has high processing activity for unburned hydrogen. The processing circuit 11 uses, for example, the temperature of the exhaust gas measured by the exhaust temperature sensor 13 as the temperature of the hydrogen processing catalyst 24. In S200, when the processing circuit 11 determines that the temperature of the hydrogen processing catalyst 24 is equal to or higher than the predetermined temperature (S200; YES), the processing circuit 11 advances the processing to S210. In S200, when the processing circuit 11 determines that the temperature of the hydrogen processing catalyst 24 is less than the predetermined temperature (S200; NO), the processing circuit 11 advances the processing to S220.

In S210, the processing circuit 11 selects the normal map MTA as the torque limit map MT to be referred to when determining the torque upper limit. Normally, the map MTA includes information about a predetermined torque-upper limit value to be used when the temperature of the hydrogen processing catalyst 24 is equal to or higher than the predetermined temperature. When S210 is executed, the processing circuit 11 temporarily ends the processing of FIG. 5.

In S220, the processing circuit 11 selects the low-temperature map MTB as the torque limit map MT to be referred to when determining the torque upper limit. The low-temperature map MTB includes a predetermined upper-torque limit used when the temperature of the hydrogen processing catalyst 24 is lower than the predetermined temperature. When S220 is executed, the processing circuit 11 temporarily ends the processing of FIG. 5.

The processing circuit 11 refers to the torque limit map MT selected by S210 or S220, and performs the processing of the torque limit shown in FIG. 3.

In FIG. 4, the predetermined torque upper limit value in the low-temperature map MTB is set to be smaller than the predetermined torque upper limit value in the normal map MTA. Therefore, when the temperature of the hydrogen processing catalyst 24 is lower than the predetermined temperature, the processing circuit 11 performs torque limiting by referring to the low temperature map MTB, and changes the torque upper limit value to a smaller value than when the temperature of the hydrogen processing catalyst 24 is equal to or higher than the predetermined temperature.

### Correction of torque upper limit value according to frequency of misfire

When performing torque limit by detecting misfire, the processing circuit 11 corrects the torque upper limit value determined based on the temperature of the hydrogen processing catalyst 24 so as to further reduce the torque upper limit value as the frequency of detecting misfire in the engine 21 increases. At this time, for example, the processing circuit 11 calculates the misfire rate, which is the number of misfire detections per predetermined number of revolutions of the engine 21, and performs correction so that the higher the misfire rate, the lower the torque upper limit value. The misfire rate is, for example, the number of misfires detected during 100 revolutions of the crankshaft 34 of the engine 21.

As shown in FIG. 4, in the normal map MTA and the low-temperature map MTB which are the torque limit map MT, a correcting factor is determined in advance in accordance with the misfire rate. The correction coefficient is set such that the larger the misfire rate, the smaller the value. First, the processing circuit 11 acquires a predetermined torque upper limit value in the torque limit map MT selected based on the temperature of the hydrogen processing catalyst 24. Thereafter, the processing circuit 11 multiplies the acquired torque upper limit value by a correction coefficient corresponding to the misfire rate to further reduce the torque upper limit value. Then, the processing circuit 11 determines the corrected torque upper limit value as the torque upper limit value at the time of performing the torque limit. Thus, the processing circuit 11 performs correction so as to further reduce the torque upper limit value as the misfire rate increases, that is, as the frequency of misfire increases. The value of the correction factor may be set as a different value for each torque limit map MT.

### Operation of the first embodiment

In the vehicle 20, the treatment activity of the hydrogen processing catalyst 24 for treating unburned hydrogen increases as the temperature of the catalyst increases. When the temperature of the hydrogen processing catalyst 24 is lower than the predetermined temperature, the processing activity of the hydrogen processing catalyst 24 is lower than that in the case where the temperature is equal to or higher than the predetermined temperature. Therefore, when the temperature of the hydrogen processing catalyst 24 is lower than the predetermined temperature, there is a possibility that the hydrogen processing catalyst 24 cannot sufficiently treat the unburned hydrogen.

When the torque upper limit value, which is the upper limit value of the required torque, is lowered, the amount of hydrogen supplied to the engine 21 is limited. When the temperature of the hydrogen processing catalyst 24 at the time of misfire detection is lower than the predetermined temperature, the processing circuit 11 makes the torque upper limit value smaller than the case of the predetermined temperature or higher. Thus, when the temperature of the hydrogen processing catalyst 24 is lower than the predetermined temperature and the processing activity is low, the processing circuit 11 further limits the amount of hydrogen supplied to the engine 21 to reduce the amount of unburned hydrogen generated by misfire. Thus, the control device 10 can suppress the amount of hydrogen discharged without being processed by the hydrogen processing catalyst 24.

The processing circuit 11 corrects the torque upper limit value so as to greatly reduce the torque upper limit value as the misfire rate indicating the frequency at which misfire is detected increases. The greater the misfire rate, the greater the amount of unburned hydrogen discharged. When the misfire rate is large, the processing circuit 11 adds correction so that the supply amount of hydrogen to the engine 21 becomes smaller, thereby reducing the amount of unburned hydrogen discharged during misfire.

### Effect of the 1 embodiment

(1-1) According to the control device 10, even when the treatment activity of the hydrogen processing catalyst 24 is low, it is possible to suppress the unburned hydrogen caused by misfire from being discharged to the outside through the exhaust pipe.

(1-2) The processing circuit 11 detects misfire and performs torque limitation. At this time, the processing circuit 11 corrects the torque upper limit value determined based on the temperature of the hydrogen processing catalyst 24 so as to further reduce the torque upper limit value as the frequency of detecting a misfire in the engine 21 increases.

The higher the frequency of misfire, the greater the amount of unburned hydrogen discharged. The processing circuit 11 corrects the torque upper limit value so as to greatly reduce the torque upper limit value as the frequency of detecting misfire increases. That is, when the frequency of misfire is high, correction is applied so that the supply amount of hydrogen to the engine 21 is reduced, and the amount of unburned hydrogen discharged during misfire is reduced.

According to the control device 10, even when the misfire of the engine 21 frequently occurs, an optimum torque limit can be performed.

(1-3) The processing circuit 11 calculates the misfire rate, which is the number of misfire detections per predetermined number of revolutions in the engine 21, and performs correction so that the higher the misfire rate, the lower the torque upper limit value.

### Second Embodiment

The higher the misfire rate, the higher the frequency of misfire. By performing correction according to the misfire rate, the control device 10 can perform an optimum torque limit even when the misfire of the engine 21 frequently occurs.

Next, a second embodiment of the control device 10 will be described with reference to FIGS. 3 and 6. The following mainly describes portions different from those of the first embodiment. A detailed description of a member that overlaps with the first embodiment will be omitted. The second embodiment is different from the first embodiment in that the processing circuit 11 selects the torque limit map MT referred to from the three torque limit map MT of the normal map MTA, the first low-temperature map, and the second low-temperature map. The storage device 12 stores three torque limit map MT for each of the plurality of temperature segments as information regarding the torque limit for which the torque upper limit value is determined.

### Torque limit map MT selection

When the misfire is detected, the processing circuit 11 determines a temperature category including the temperature of the hydrogen processing catalyst 24 when the misfire is detected. Then, the processing circuit 11 determines the torque upper limit based on the torque limit map MT corresponding to the temperature category including the temperature of the hydrogen processing catalyst 24 when the misfire is detected. The processing circuit 11 performs the following processing to determine a temperature segment including the temperature of the hydrogen processing catalyst 24, and selects a torque limit map MT corresponding to the temperature segment.

FIG. 6 is a flowchart showing a process in which the processing circuit 11 selects the torque limit map MT in the second embodiment. As in the first embodiment, the processing circuit 11 repeatedly executes the processing illustrated in FIG. 6 at predetermined time intervals.

In S300, the processing circuit 11 determines whether or not the temperature of the hydrogen processing catalyst 24 is equal to or higher than a predetermined temperature. The predetermined temperature is the same as that of the first embodiment. In S300, when the processing circuit 11 determines that the temperature of the hydrogen processing catalyst 24 is equal to or higher than the predetermined temperature (S300; YES), the processing circuit 11 advances the processing to S310. In S300, when the processing circuit 11 determines that the temperature of the hydrogen processing catalyst 24 is less than the predetermined temperature (S300; NO), the processing circuit 11 advances the processing to S320.

In S310, as in the first embodiment, the processing circuit 11 selects the normal map MTA as the torque limit map MT. The normal map MTA is the same as that of the first embodiment. When S310 is executed, the processing circuit 11 temporarily ends the processing of FIG. 6.

In S320, the processing circuit 11 determines whether or not the temperature of the hydrogen processing catalyst 24 is equal to or higher than the border temperature. The boundary temperature is a temperature lower than a predetermined temperature.

In S320, when the processing circuit 11 determines that the temperature of the hydrogen processing catalyst 24 is equal to or higher than the border temperature (S320; YES), the processing circuit 11 advances the processing to S330. In S320, when the processing circuit 11 determines that the temperature of the hydrogen processing catalyst 24 is less than the border temperature (S320; NO), the processing circuit 11 advances the processing to S340.

In S330, the processing circuit 11 selects the first low temperature map as the torque limit map MT. The first low-temperature map includes information on a predetermined torque upper limit value used when the temperature of the hydrogen processing catalyst 24 is equal to or higher than the boundary temperature and lower than the predetermined temperature. When S330 is executed, the processing circuit 11 temporarily ends the processing of FIG. 6.

In S340, the processing circuit 11 selects the second low temperature map as the torque limit map MT. The second low temperature map includes information on a predetermined torque upper limit value to be used when the temperature of the hydrogen processing catalyst 24 is lower than the boundary temperature. When S340 is executed, the processing circuit 11 temporarily ends the processing of FIG. 6.

The processing circuit 11 refers to the torque limit map MT selected by S310, S330 or S340, and executes the torque limit processing illustrated in FIG. 3 as in the first embodiment.

Similar to the normal map MTA shown in FIG. 4, the first low-temperature map and the second low-temperature map include information on the upper limit and the correction factor corresponding to the misfire rate. At this time, the predetermined torque upper limit value in the first low-temperature map is smaller than the predetermined torque upper limit value in the normal map MTA. The predetermined torque upper limit value in the second low-temperature map is smaller than the predetermined torque upper limit value in the first low-temperature map. Therefore, by referring to the torque limit map MT selected in the process shown in FIG. 6, when the temperature of the hydrogen processing catalyst 24 is lower than the predetermined temperature, the processing circuit 11 changes the torque upper limit value to a smaller value as the temperature of the hydrogen processing catalyst 24 is lower.

### Operation of the second embodiment

As in the first embodiment, the processing circuit 11 performs correction so as to further reduce the torque upper limit value according to the frequency of misfire.

The lower the temperature of the hydrogen processing catalyst 24, the lower the treatment activity of the hydrogen processing catalyst 24. The processing circuit 11 determines the torque upper limit based on the torque limit map MT corresponding to the temperature segment including the temperature of the hydrogen processing catalyst 24. The upper torque limit in the respective torque limit maps MT is set to be smaller as the temperature of the catalyst is lower and the quantity of unburned hydrogen that can be processed by the hydrogen processing catalyst 24 is smaller. That is, the processing circuit 11 limits the amount of hydrogen supplied to the engine 21 as the temperature of the catalyst is lower. Thus, the processing circuit 11 suppresses the amount of unburned hydrogen discharged without being processed by the hydrogen processing catalyst 24.

### Effect of the 2 embodiment

The second embodiment has the following effects in addition to the effects of the first embodiment.

(2-1) When the temperature of the hydrogen processing catalyst 24 at the time of detecting misfire is lower than the predetermined temperature, the processing circuit 11 decreases the torque upper limit value as the temperature of the hydrogen processing catalyst 24 decreases.

The lower the temperature of the hydrogen processing catalyst 24, the lower the treatment activity of the hydrogen processing catalyst 24. The processing circuit 11 reduces the torque upper limit value and limits the amount of hydrogen supplied to the engine 21 as the catalyst temperature at the time of misfire detection is low and the amount of unburned hydrogen that can be processed by the hydrogen processing catalyst 24 is small. In this way, the processing circuit 11 suppresses the amount of unburned hydrogen discharged without being processed by the hydrogen processing catalyst 24. That is, the processing circuit 11 changes the torque upper limit value to the torque upper limit value corresponding to the processing activity of the hydrogen processing catalyst 24 based on the temperature of the hydrogen processing catalyst 24.

According to the control device 10, it is possible to perform the torque limit corresponding to the processing capacity of the unburned hydrogen that changes in accordance with the temperature of the hydrogen processing catalyst 24.

(2-2) The control device 10 includes a storage device 12 that stores, for each of the plurality of temperature segments, a torque limit map MT that is related to a torque limit for which a torque upper limit value is determined. When the misfire is detected, the processing circuit 11 determines a temperature category including the temperature of the hydrogen processing catalyst 24 when the misfire is detected. Then, the processing circuit 11 determines the torque upper limit based on the torque limit map MT corresponding to the temperature category including the temperature of the hydrogen processing catalyst 24 when the misfire is detected.

The storage device 12 stores a torque limit map MT in which a torque upper limit is determined in advance for each thermal segment. The processing circuit 11 determines the torque upper limit based on the torque limit map MT corresponding to the temperature segment including the temperature of the hydrogen processing catalyst 24.

### Example of change

According to the control device 10, it is possible to easily perform an appropriate torque limit corresponding to the processing capacity of the hydrogen processing catalyst 24.

Elements that can be changed in common in the above-described embodiments include the following. The following modifications may be implemented in combination with each other to the extent that they are not technically inconsistent.

· When the temperature of the hydrogen processing catalyst 24 is lower than the predetermined temperature, the control device 10 may continuously change the torque upper limit value according to the temperature of the hydrogen processing catalyst 24 without classifying the temperature of the hydrogen processing catalyst 24. For example, an arbitrary function including the temperature of the hydrogen processing catalyst 24 as a variable may be defined to calculate a torque upper limit value suitable for the temperature of the hydrogen processing catalyst 24. In this case, the processing circuit 11 may calculate the torque upper limit value each time based on the temperature of the hydrogen processing catalyst 24 at the time of misfire.

· The processing circuit 11 may determine the frequency of misfire without calculating the misfire rate. For example, the processing circuit 11 may calculate a time interval of misfire in the engine 21 and determine that the frequency of misfire is high when the interval is short.

· The processing circuit 11 performs torque limiting based only on the misfire rate without distinguishing the misfired cylinders 31. On the other hand, the processing circuit 11 may identify the misfired cylinder 31 and perform correction according to the misfire mode. The misfire mode is, for example, a single-cylinder continuous misfire in which the same cylinder 31 is misfire in successive cycles. The misfire mode is, for example, a two-cylinder continuous misfire in which two different cylinders 31 continuously misfire within the same cycle. As an example, in a case where a two-cylinder continuous misfire is detected, the processing circuit 11 may make the correction coefficient smaller than in a case where a one-cylinder continuous misfire is detected. As described above, the processing circuit 11 according to the first embodiment can grasp the frequency of misfire based on the simple arithmetic processing of calculating the misfire rate and perform the optimum torque limit as compared with the case where the torque limit according to the mode of misfire is performed.

· The processing circuit 11 may not perform correction according to the frequency of misfire.

· The engine 21 controlled by the control device 10 is not limited to a V-type internal combustion engine. In the case of a hydrogen engine, the engine 21 may be in the form of a series engine, a horizontally opposed engine, or the like.

· The engine 21 is not limited to a six-cylinder internal combustion engine. The engine 21 may be a single cylinder, two cylinders, or a multi-cylinder engine of three or more cylinders. For example, the engine 21 may be a three-cylinder, four-cylinder, or eight-cylinder hydrogen engine.

· The processing circuit 11 uses the temperature of the exhaust temperature sensor 13 as the temperature of the hydrogen processing catalyst 24. The processing circuit 11 may perform some arithmetic processing on the temperature of the exhaust temperature sensor 13 to calculate an estimated value of the temperature of the hydrogen processing catalyst 24. The processing circuit 11 may execute the processing of FIGS. 5 and 6 using the estimated value as the temperature of the hydrogen processing catalyst 24.

· The method in which the processing circuit 11 detects misfire is not limited to the above method in which T30 [60] is compared with T30 [0]. Based on T30, the processing circuit 11 may perform a process different from the above-described process to detect misfire.

· The processing circuit 11 may detect misfire without being based on T30.

· The control device 10 may not be one of the control devices incorporated in the engine ECU mounted in the vehicle 20. The control device 10 may be a control device mounted on the vehicle 20 and independent of the engine ECU.

· The storage device that stores the torque limit map MT may not be the storage device 12 of the control device 10. It may be stored in a storage device of a control device different from the control device 10.

What is claimed is:

1. A control device for an internal combustion engine that is applied to the internal combustion engine using hydrogen as a fuel, and that controls a fuel supply amount for the internal combustion engine in accordance with required torque, the control device comprising a processing circuit, wherein the processing circuit is configured to
perform torque limitation to reduce a torque upper limit value as an upper limit of the required torque when a misfire in the internal combustion engine is detected, and
when a temperature of an exhaust control catalyst provided in an exhaust path of the internal combustion engine at a time when the misfire is detected is lower than a predetermined temperature, reduce the torque upper limit value to be less that at a time when the temperature of the exhaust control catalyst at the time when the misfire is detected is equal to or higher than the predetermined temperature.

2. The control device according to claim 1, wherein when the temperature of the exhaust control catalyst at the time when the misfire is detected is lower than the predetermined temperature, the processing circuit reduces the torque upper limit value to be smaller as the temperature of the exhaust control catalyst is lower.

3. The control device according to claim 2, further comprising a storage device that stores information relating to the torque limitation that determines the torque upper limit value for each of a plurality of temperature segments, wherein when the misfire is detected, the processing circuit determines the temperature segment including the temperature of the exhaust control catalyst at a time when the misfire is detected, and determines the torque upper limit value based on the information corresponding to the temperature segment including the temperature of the exhaust control catalyst at the time when the misfire is detected.

4. The control device according to claim 1, wherein when the misfire is detected and the torque limitation is performed, the processing circuit performs correction on the torque upper limit value determined based on the temperature of the exhaust control catalyst so as to further reduce the torque upper limit value to a greater degree as a frequency of detecting the misfire in the internal combustion engine is higher.

5. The control device according to claim 4, wherein the processing circuit calculates a misfire rate that is a number of times of detection of the misfire in the internal combustion engine per predetermined number of revolutions, and perform the correction so as to reduce the torque upper limit value to a greater degree as the misfire rate is higher.
